(19) United States
(12) Patent Application Publication
(10) Pub. No.: US 2011/0119657 A1
(43) Pub. Date: May 19, 2011

(54) USING FUNCTION CALLS AS COMPILER DIRECTIVES

(76) Inventors: Martin Vorbach, Lingenfeld (DE); Frank May, Munchen (DE); Weinhardt Markus, Munchen (DE)

(21) Appl. No.: 12/746,570

(22) PCT Filed: Dec. 8, 2008
(86) PCT No.: PCT/EP08/10392

§ 371 Date: Jan. 24, 2011

(30) Foreign Application Priority Data
Dec. 7, 2007 (EP) 07023731.8

(51) Int. Cl. G06F 9/45

(52) U.S. Cl. 717/140

(57) ABSTRACT

A method for passing compiler directives into a compiler wherein empty function calls are defined, which call no function, but define compiler directives by its name, is suggested. Thus, by allowing empty functions calls and by handling them automatically, in particular in the automated way suggested, significant improvements over the prior art can be obtained.

### CROSS-REFERENCES TO RELATED APPLICATIONS

This application is the National Stage of International Application No. PCT/EP08/010392, filed Dec. 8, 2008, which claims priority to European Patent Application No. EP 07023731.8, filed Dec. 7, 2007, the entire contents of each of which are expressly incorporated herein by reference.

### FIELD OF THE INVENTION

The present invention refers to methods for compiling high level language code to assembly and/or object code. In detail it shows an efficient method to pass compiler directives, e.g. target machine dependent hints, to any transformation, optimization, and/or emitting stage inside the compiler.

### BACKGROUND OF THE INVENTION

The present invention is for example applicable for compilers for traditional processor architectures such as CISC, RISC, VLIW, massive parallel computers, reconfigurable processors or co-processors such as FPGAs, PACT XPP processors, and any combination of those architectures or machines.

The present invention us for example appropriate to modern languages such as C, C++, and especially JAVA, but also traditional languages such as FORTRAN, PASCAL.

Reconfigurable architectures may be for example devices (VPU) which a plurality of elements being configurable in function and connection at runtime. Such elements may be and/or comprise for example Arithmetic Logic Units (ALUs), FPGA elements such as CLBs, Input/Output cells, memories, analog units and so on.

The present invention is for example applicable in particular with FPGAs, such as, e.g. XILINX Virtex, ALTERA, (re)configurable processors, such as, e.g. PACT XPP, AMBRIC, MATHSTAR, STRETCH, and/or processors, e.g. STRETCHPROCESSOR, CRADLE, CLEARSPEED, INTEL, AMD, ARM. The (re)configurable processors may be coarse granular and/or mixed coarse and fine granular data processing cells in, e.g. a two- or higher dimensional array that also may have a plurality of different cells, e.g. storage cells. Each cell or a plurality of the cells may be configurable and/or reconfigurable at run time and may be addressable for configuration and/or reconfiguration. It may be preferred if a configuration/reconfiguration can be effected without adversely impairing other cells.

It should be noted that major aspects of the VPU technology, to which the present invention may be, inter alia, applicable are described in the following patents and patent applications of the applicant, though none of the features disclosed therein is to restrict the present invention to only devices or parts thereof or methods having features as described therein:

P 44 16 881.0-53, German Patent Application No. DE 197 81 412.3, German Patent Application No. DE 197 81 483.2, German Patent Application No. DE 196 54 846.2-53, German Patent Application No. DE 196 54 593.5-53, German Patent Application No. DE 197 04 044.6-53, German Patent Application No. DE 198 80 129.7, German Patent Application No. DE 198 61 088.2-53, German Patent Application No. DE 199 80 312.9, International Patent Application No. PCT/DE00/01869, German Patent Application No. DE 100 36 627.9-33, German Patent Application No. DE 100 28 397.7, German Patent Application No. DE 101 10 530.4, German Patent Application No. DE 101 11 014.6, International Patent Application No. PCT/EP00/10516, European Patent Application No. EP 01 102 674.7, German Patent Application No. DE 102 06 856.9, U.S. patent application Ser. No. 60/317,876, German Patent Application No. DE 102 02 044.2, German Patent Application No. DE 101 29 237.6-53, German Patent Application No. DE 101 39 170.6, International Patent Application No. PCT/EP03/09957, International Patent Application No. PCT/EP04/006547, European Patent Application No. EP 03 015 015.5, International Patent Application No. PCT/EP04/009640, International Patent Application No. PCT/EP04/003603, European Patent Application No. EP 04 013 557.6, European Patent Application No. EP 05 020 772.9, European Patent Application No. EP 05 003 174.9, European Patent Application No. EP 05 017 798.9, European Patent Application No. EP 05 017 844.1, European Patent Application No. EP 05 027 333.3, German Patent Application No. DE 10 2006 003 275.6, German Patent Application No. DE 10 2006 004 151.8, European Patent Application No. EP 06 400 003.7, European Patent Application No. EP 06 001 043.6, German Patent Application No. DE 10 2007 056 505.6, German Patent Application No. DE 10 2007 056 806.3, and German Patent Application No. DE 10 2007 057 642.2.

All listed documents are incorporated herein by reference in their entirety, in particular regarding details of a target architecture. An object of the present invention is to provide new technologies for commercial exploitation.

Parts of this kind may be known for example from the applicants' XPP processor technology. It may comprise at least a one or multi-dimensional, e.g. 2-dimensional, arrangement of so called PAEs (processing array elements). PAEs may be for example arithmetic, logic, and/or analog elements, memory units, network or connectivity, and/or units for external communication (IO). PAEs may be connected together via one or multiple bus systems which can be implemented hierarchically segmented and/or operated at clock frequencies different from clock frequencies of PAEs. PAEs of any kind may be arranged in any combination or hierarchy, which arrangement may be called PAE-Array or PA.

In addition to XPPs or VPUs, the present invention may be applicable to other technologies, such as systolic Arrays, neuronal nets, multi processor systems, processors comprising multiple processing units and/or cores, logic units, network devices, crossbar switches and FPGAs, DPGAs and the like, e.g. those mentioned above.

When compiling source code, for example C code, for a specific hardware, for example reconfigurable processors, it is often necessary to provide additional information to the compiler that is not part of the standard programming language.

Examples include annotations for partitioning, for certain optimizations as loop unrolling or for accessing special hardware blocks like streaming IO ports.

Traditional ways of providing such information include:
Using language extensions specific for one or several compilers. The disadvantage may be that the resulting source code can no longer be compiled with other compilers for the same language.
Use comments with specific contents. The disadvantage may be that comments are removed at an early stage of the compilation and are no longer available for latter compiler stages.
Where available, use compiler specific hints and/or directives as defined by the programming language standard, for example #pragma in the C programming language. Those hints may be ignored by compilers not implementing and/or understanding them. The disadvantage may be again that those hints may not be available to latter stages of the compiler and/or cannot be uniquely associated with a certain part of the source code.

### SUMMARY OF THE INVENTION

Example embodiments of the present invention provide a new approach that may avoid all disadvantages described above. Hints and/or directives may be embedded into the source code as standard function calls with specific names. The resulting source code may still be compiled with any compiler, just by giving an empty function definition. The function calls may be visible at all stages of the compiling process. And their location may allow to uniquely identify the parts of the source code they apply to, again in all compilation stages.

These advantages will be further detailed in the following sections.

### DETAILED DESCRIPTION

### The Structure of a Compiler

As a basis for a more in-depth discussion, the general structure of a compiler is described: A compiler may work in several stages, each working on the results computed by the previous stages.

The first stage may be called Preprocessing. This stage may be optional, but implemented by most compilers. It may remove and/or expand certain constructs used by the programmer for convenience. Examples may be including other source files and expanding macros. Comments may usually be removed at this stage.

The second stage may be the Compiler Frontend. It may parse the source code and create a compiler internal representation of the program, for example as dataflow and control graphs. This frontend may contain language extensions that add hardware specific information to the internal representation.

The third stage may be called Optimization, and may work on the internal representation generated by the frontend. It may include various transformations for modifying, compacting or extending the program. During this stage, the structure (for example as dataflow and control graphs) may be changed significantly from the original code. For that reason, uniquely identifying certain lines in the source code with certain parts in the internal representation may become difficult, if not impossible.

The last stage may be the Compiler Backend. This may be the part that generates (emits) the code for a specific hardware, based on the optimized internal representation of the program.

The reason for this multi-stage approach may be to make the compiler modular. Compilers may typically contain various frontends for different programming languages, for example C, C++, Java, Fortran, and several backends generating code for different hardware architectures, for example various RISC, VLIW and reconfigurable processors. The compiler may need to be able to combine any frontend with any backend, so that all supported input languages may be compiled for any supported hardware platform. That means, the compiler frontends may be language specific, but should not contain any hardware specific parts. The other way around, compiler backends may be hardware specific, but should not contain any language specific parts.

### Requirements for Compiler Hints and Directives

From above descriptions we arrive at the following requirements that may be met by any compiler-specific hints and directives that are not part of the standard input language:
The source code containing the hints and directives should still properly compile with any other compiler for the same programming language, resulting in a working binary.
All frontends, that means all input languages, are able to handle the hints and/or directives used during optimization and in the backends.
All backends work properly with all hints and/or directives, even if not all backends implement all of them.
The hints and/or directives are available in all stages of the compilation process, especially in the backends that optimize for a particular hardware.
If a hint or directive is associated with a certain part of the program, this association is intact in all stages of the compilation process. That means, the part of the compiler internal representation, to which the hint or directive applies, is uniquely identifiable.

### State of the Art

The following methods to pass directives to the compiler are known by the state of the art.
Language extensions, if implemented carefully, may fulfill all requirements, but according software code may need to compile on other compilers and/or target platforms too. Source code containing hints and/or directives for a certain compiler may no longer be compiled on other compilers, that do not implement the same language extensions.
Compiler hints and/or directives conforming to the input language, as for example the C #pragma directives, may be ignored by other compilers, but they are usually not preserved well over the compiler stages. Even if they may still be available in the backend, it may be impossible to exactly identify the part of the internal representation they refer to after optimization. Moreover, not all input languages, that means not all frontends, may provide this kind of standard construct for compiler specific hints and directives.
Comments may usually be removed in an early compilation stage. Even if comments may be preserved in the internal representation of the program, they may suffer the problem that it may be impossible to exactly identify the part of the internal representation they refer to after optimization.

### Function Calls for Passing Compiler Directives

The present invention may use standard function calls for compiler hints and/or directives, with the following properties:
All functions used as hints and/or directives may start with a specific prefix to easily distinguish them from other real function calls. This distinction may be necessary for both the programmer and the compiler.
The source code may contain proper function declarations and empty definitions of these functions.

The requirements for this new approach for implementing compiler hints and/or directives are discussed below:
To other compilers a hint or directive looks just like an empty function call that may be optimized away. The source code may be properly compiled to a working binary.
Function calls are part of all programming languages, so the same hints and/or directives can be supported by any existing or future compiler frontend. Moreover, new hints and/or directives may be added, without any modification to the frontend.
A backend not implementing a certain hint or directive may see it as an empty function call that may be optimized away.
Function calls may be an integral part of the internal representation of a program and hence may be properly preserved over all stages of the compilation process.
Function calls are linked to the semantics of the programming language. These semantics are preserved in the internal representation over all compilation stages. This may make it possible to uniquely identify the part of the internal representation, a hint or directive formulated as a function call refers to.

Thus, the present invention describes a method for passing compiler directives into a compiler wherein empty function calls may be defined, which call no function, but define compiler directives by its name. Thus, by allowing empty functions calls and by handling them automatically, in particular in the automated way suggested, significant improvements over the prior art may be obtained.

1. (canceled)

2. A computer-implemented method for passing compiler directives into a compiler, comprising:
defining empty function call structures having names which define compiler directives and which call no function.

3. A computer-implemented method for passing compiler directives into a compiler, comprising:
providing, by a computer processor, code to a compiler, the code including empty function call structures having names which define compiler directives and which call no function.
